(19) United States
(12) Patent Application Publication
(10) Pub. No.: US 2013/0346907 A1
(43) Pub. Date: Dec. 26, 2013

(54) SPRINGBOARD TOOLBAR

(71) Applicants: Udo Arend, Heidelberg (DE); Johan Christiaan Peters, Sankt Leon-Rot (DE); Vera Legisa, Karlsruhe (DE); Rainer Matthias, Berlin (DE)

(72) Inventors: Udo Arend, Heidelberg (DE); Johan Christiaan Peters, Sankt Leon-Rot (DE); Vera Legisa, Karlsruhe (DE); Rainer Matthias, Berlin (DE)

(21) Appl. No.: 13/531,323

(22) Filed: Jun. 22, 2012

(51) Int. Cl. G06F 3/048

(52) U.S. Cl. 715/779

(57) ABSTRACT

A method may include generating a desktop including a plurality of objects organized in accordance with at least one of a theme and a structure; generating a toolbar configured for presentation with the desktop; and generating, based on the multi-level zoom, a second view representative of the at least one of the plurality of objects and a third view representative of the at least one of the plurality of objects, the second view providing more content of the at least one of the plurality of objects when compared to the first view, and the third view providing more content of the at least one of the plurality of objects when compared to the second view, the first, second, and third views maintaining the same context within the toolbar, when presented with respect to the toolbar.

### FIELD

The present disclosure generally relates to data processing and, in particular, user interfaces.

### BACKGROUND

Various organizations make use of enterprise resource planning (ERP) software architectures to provide an integrated, computer-based system for management of internal and external resources, such as for example tangible assets, financial resources, materials, customer relationships, and human resources. In general, an ERP software architecture is designed to facilitate the flow of information between business functions inside the boundaries of the organization and manage the connections to outside service providers, stakeholders, and the like. Such architectures often include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate on a local area network or over a network, such as for example the Internet, a wide area network, a local area network, or the like.

As part of the installation process of the core software platform on computing hardware owned or operated by the organization, one or more customized features, configurations, business processes, or the like may be added to the default, preprogrammed features such that the core software platform is configured for maximum compatibility with the organization's business processes, data, and the like.

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. Smaller organizations can also benefit from use of ERP functionality. However, such an organization may lack the necessary hardware resources, IT support, and/or consulting budget necessary to make use of a standalone ERP software architecture including on-premises components. As such, the organization can in some cases be more effectively served by an on-demand system or component, such as a software as a service (SaaS) arrangement in which the ERP system architecture is hosted on computing hardware such as servers and data repositories that are maintained remotely from the organization's location and accessed on-demand by authorized users at the organization via a thin client, such as for example a web browser, over a network.

### SUMMARY

Methods and apparatus, including computer program products, are provided for a desktop. In one aspect, there is provided a method. The method may include generating a desktop including a plurality of objects organized in accordance with at least one of a theme and a structure; generating a toolbar configured for presentation with the desktop, the toolbar being configured with at least one of the plurality of objects presented as a first view configured for multi-level zoom; and generating, based on the multi-level zoom, a second view representative of the at least one of the plurality of objects and a third view representative of the at least one of the plurality of objects, the second view providing more content of the at least one of the plurality of objects when compared to the first view, and the third view providing more content of the at least one of the plurality of objects when compared to the second view, the first, second, and third views maintaining the same context within the toolbar, when presented with respect to the toolbar.

In some implementations, the above-noted aspects may further include additional features described herein including one or more of the following. The theme may include at least one of a project, a role of a user, and a work flow. The structure may include a grid. The plurality of objects may include a plurality of graphical elements representative of a link to an action on a business object in a enterprise resource planning system. A first selection of the multi-level zoom at the toolbar may provide the second view, and a second selection of the multi-level zoom at the toolbar may provide the third view.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1A depicts an example of a desktop, in accordance with some exemplary implementations;

FIGS. 1B, 1C, 1D, 1E, and 1F depict examples of springboard toolbars, in accordance with some exemplary implementations;

FIG. 2 depicts an example implementation of a spatial overview of a desktop, in accordance with some exemplary implementations;

FIG. 3 depict an example implementation of multi-level zoom on an icon of the desktop, in accordance with some exemplary implementations;

FIGS. 4, 5A, 5B, and 5C depict examples of wireframes of desktops, in accordance with some exemplary implementations;

FIG. 6 depicts an example of a system implemented in a multi-tenant cloud-based framework, in accordance with some exemplary implementations;

FIG. 7 depicts an example of metadata repository for multi-tenant data, in accordance with some exemplary implementations; and

FIG. 8 depicts an example process, in accordance with some exemplary implementations.

Like labels are used to refer to same or similar items in the drawings.

### DETAILED DESCRIPTION

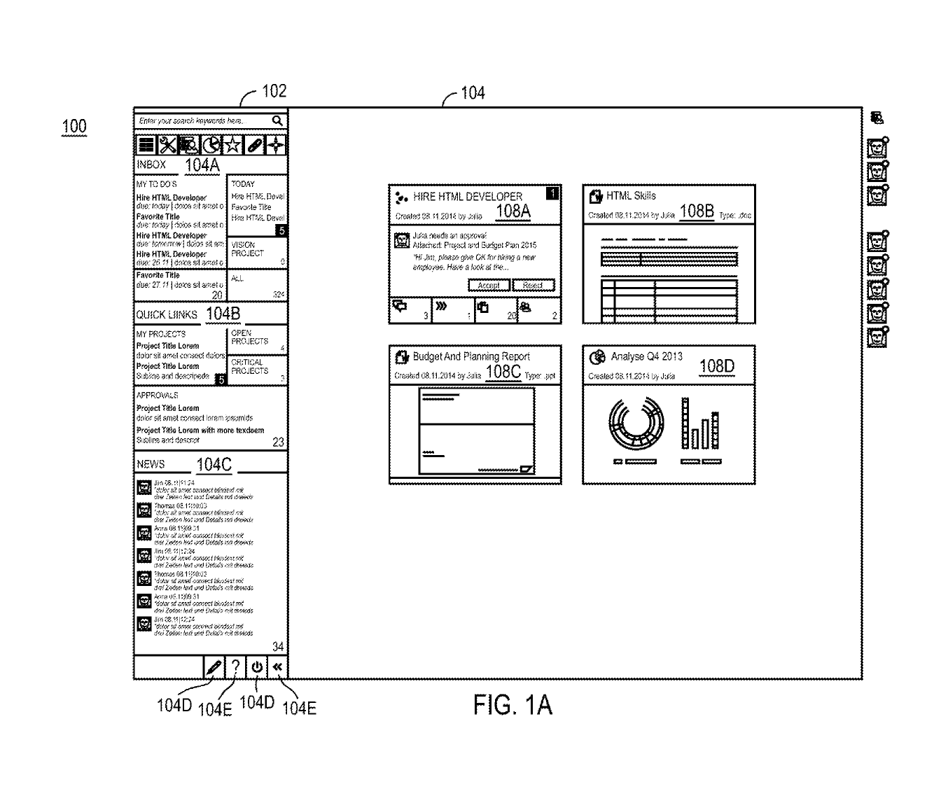

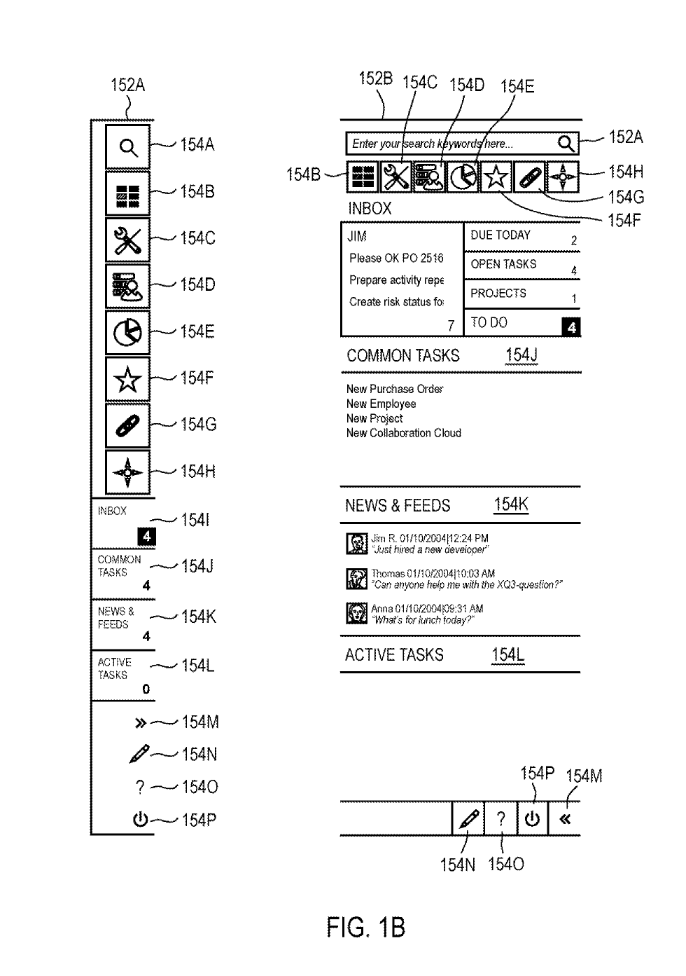

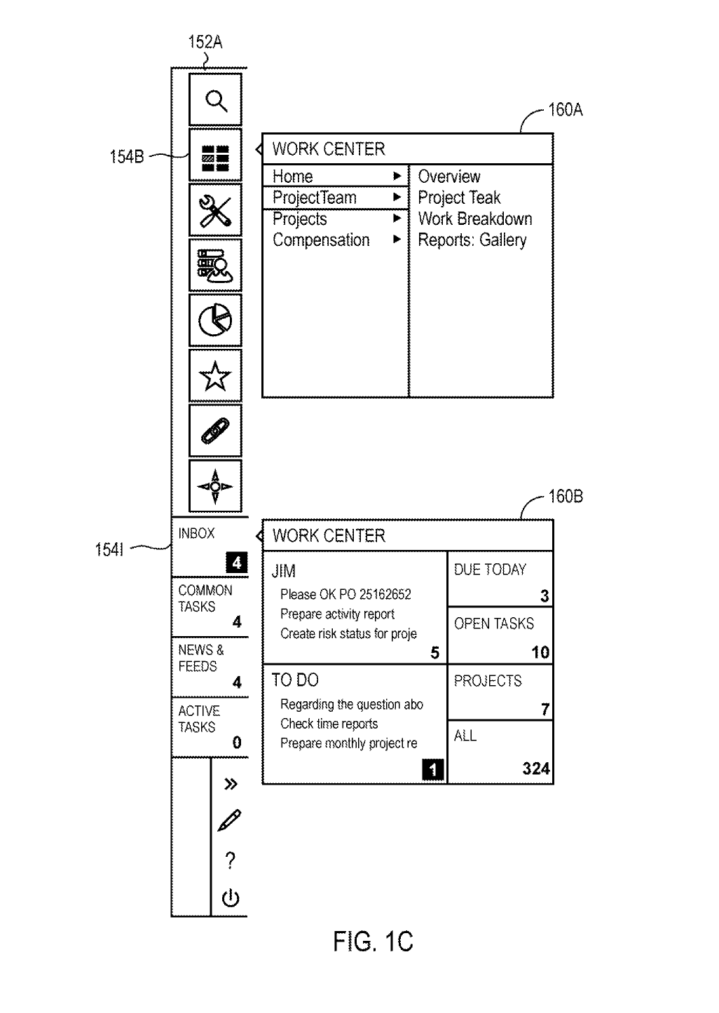

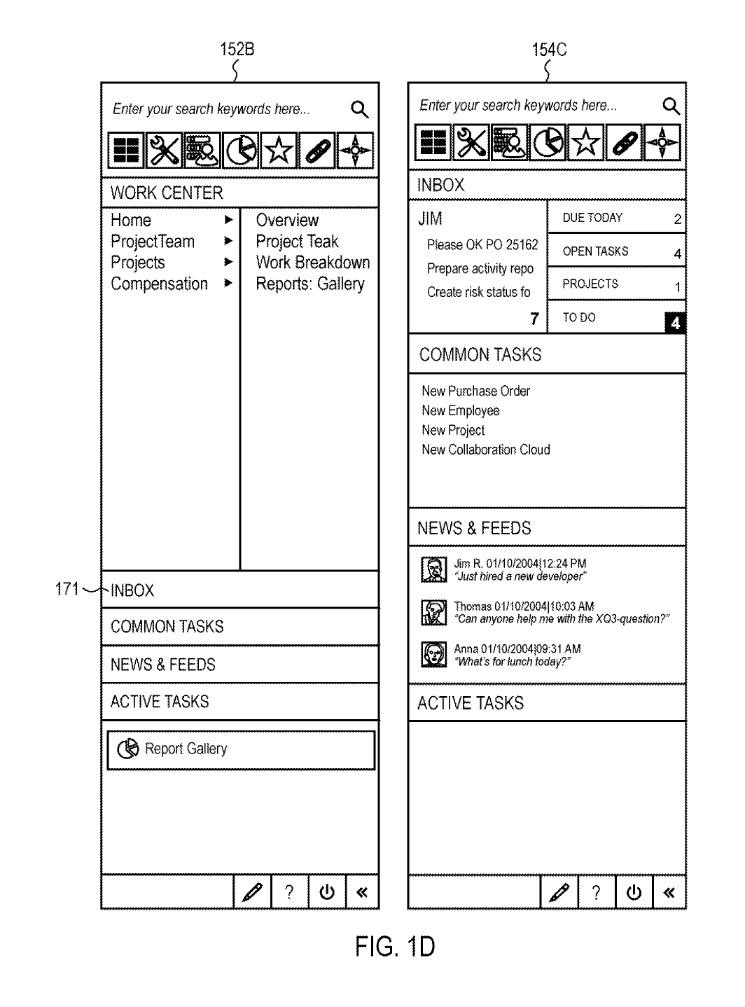

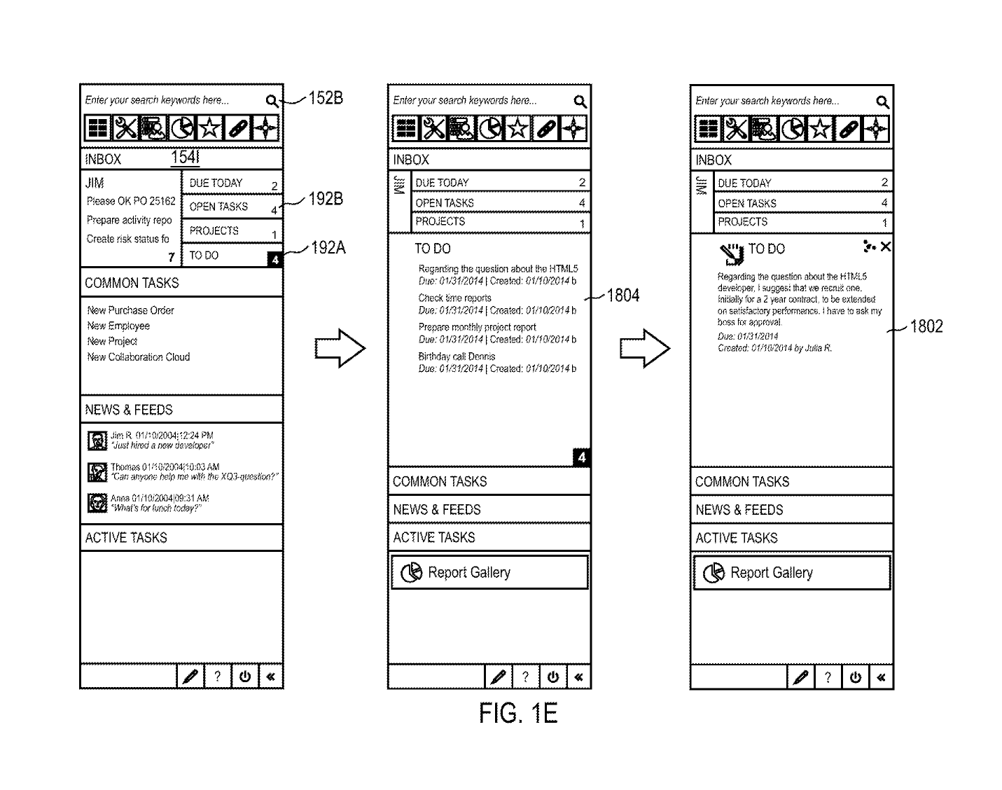

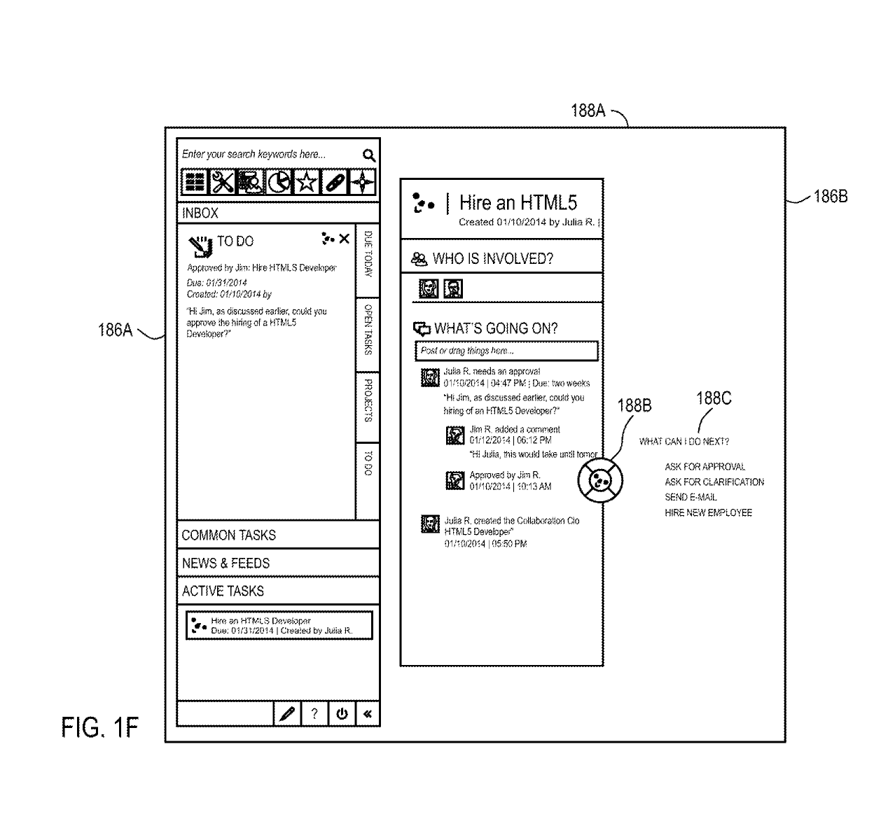

FIG. 1A depicts an example of a desktop 100 generated and then presented as a user interface at a processor. The desktop 100 may include a so-called “springboard” toolbar portion 102 and a desktop workspace portion 104 (which is also referred to as a desktop).

The desktop portion 104 may comprise a virtual desktop including objects, such as objects 108A-D, arranged according to a structure or a theme. The springboard toolbar 102 refers to a collapsible tool bar portion configured to allow triggering objects by selecting the object from the springboard. Moreover, objects on the toolbars may be dragged to the workspace 104.

FIG. 1A shows that the springboard toolbar 102 (also referred to as springboard) includes objects, such as inbox 104A, quick links 104B (e.g., links to other services, websites, links that perform other actions, such as queries to business objects in an ERP system, and the like), news 104C, and tools, such as a notepad 104D, a help tool 104E, a log off icon 104F, and an expand/collapse icon 104G to expand or collapse the springboard 102. Other examples of objects include one or more of the following: a push to an email inbox, a quick link to a database or a repository (e.g., a predefined query of a business object), favorites, a task (e.g., creating a data structure such as a business object), tools, a contact tool, views, news feeds; help; status information; workflow or worklist status; personalization and customization tools; navigation tools (e.g., to navigate the desktop), and the like.

FIG. 1B depicts another example of the springboard in a collapsed configuration 152A and an expanded configuration 152B. For example, scrolling over the springboard 152A (or performing some other action) may expand springboard 152A into 152B, while scrolling over the springboard 152B may collapse the springboard into 152A.

Springboard 152A is configured to include objects which when selected provide a tool, an action, or a service. Springboard 152 includes objects, such as a search tool 154A, a view 154B (e.g., of a workcenter, a worklist, a workview, and the like), other tools 154C, contacts 154D, reports 154E generated by the ERP system, favorites 154E, links 154G, a navigator 154H, an inbox 154I, a common tasks tool 154J, a news feed 154K, an active tasks tool 154L, an expand/collapse icon 154M to expand and collapse the springboard, a personalize tool 154N, a help tool 154O, and a logout icon 154P.

Expanded springboard 152B shows an expanded form of springboard 152A. In some implementations, the objects included in springboard are configurable (e.g., by an end-user or developer of the ERP system). A user can drag an object from the springboard 152A or B and place it on the desktop 104, and move an object from the desktop 104 to the springboard.

FIG. 1C depicts an example configuration of springboard 152A with two so-called “fly outs.” The fly outs refer to additional content for an object presented in an abbreviated form. In the example of FIG. 1C, a user may perform an action (e.g., scrolling, double click, hover, and the like) with respect to the view object 154B. When this is the case, fly out 160A is presented on the desktop to show a view of an object associated with a work center, such as work centers associated with the ERP system including projects, workflows, tasks, and the like. An action with respect to inbox 154I yields fly out 160B, which corresponds to an email inbox and a to-do list for a project, a workflow, and the like at an ERP system.

FIG. 1D depicts another example configuration of a springboard 152C. In the example of FIG. 1D, a user may perform an action (e.g., scrolling, double click, hover, and the like) with respect to inbox 171. When this is the case, the inbox expands as shown at springboard 152B.

FIG. 1E depicts another example configuration of a springboard 152B. In the example of FIG. 1E, a user may perform an action (e.g., scrolling, double click, hover, and the like) with respect to inbox 154I. In some implementations, the desktop may be configured with multi-level zoom. For example, hovering over inbox 154I and scrolling a wheel on a mouse may expand the content of the inbox 154I to yield inbox 154Y, and scrolling again may yield inbox 154Z. The multi-level zoom provides more content for the object on the toolbar (which in this case is more inbox content) without changing the context of the toolbar as the toolbar keeps its original objects after the expansion. For example, scrolling while in multi-level zoom initially provides all of the items 180Y (which may correspond to work items in an ERP system) in a commotion list of inbox 154Y and continuing to scroll provides additional content 180Z for the first to do, and so forth through the content of the to-do inbox. FIG. 1E also shows that new items in the toolbar requiring attention may be highlighted 192A and total number of items 192B as well.

FIG. 1F depicts example configuration of a springboard 186A and a desktop 186B including a user interface element, such as icon 188A. Icon 188A, when selected by an action (e.g., a mouse over, click with a mouse, etc.) presents additional content 188B with respect to the object presented in the desktop 186B.

In some implementation, the springboards disclosed herein may be a component of an ERP system, such as the one described below with respect to FIG. 6. For example, the springboard may include objects which may be selected and triggered (e.g., activate, execute, and the like).

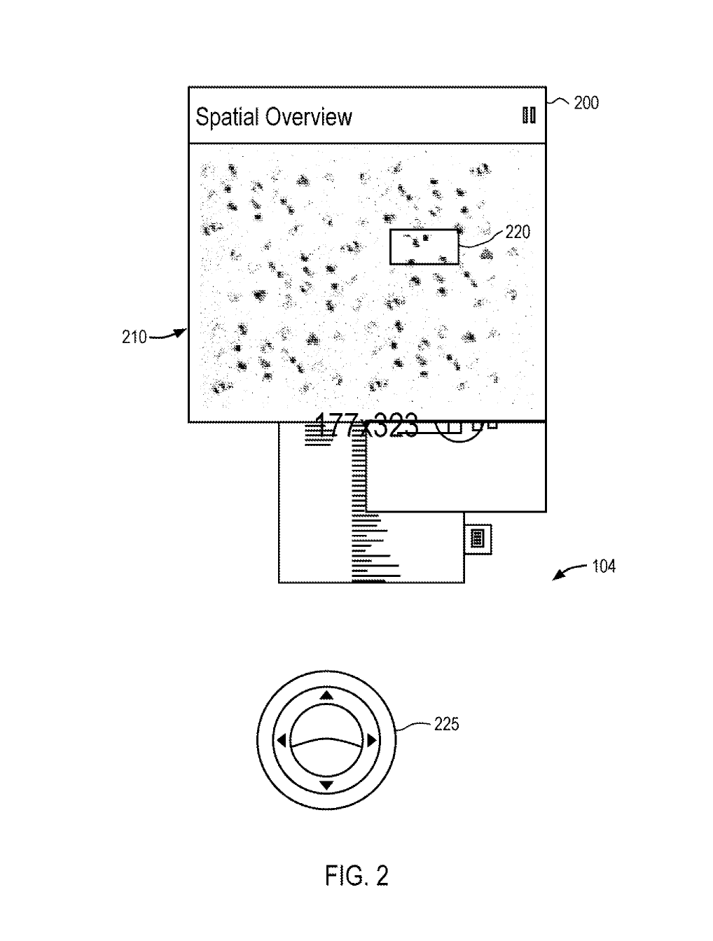

Moreover, desktop 100 may be configured as a virtual desktop. FIG. 2 depicts a spatial overview 200 of a virtual desktop, such as desktop 100. The spatial overview 200 may present dozens if not hundreds of objects 210 (depicted as small polygons or icons) of a virtual desktop organized according to a structure or a theme. The spatial overview 200 also includes a navigation tool 220 controlled by element 225 to allow a user to navigate through the objects of the virtual desktop until an object of interest is found. In the example of FIG. 2, the objects within navigation tool 220 may correspond to objects 108A-D, which may also be configured on the springboard toolbar.

Although the navigation tool 220 and controller 225 may be used to locate objects, the objects may also be accessed using a search or a filter as well. Moreover, the virtual desktop may include a plurality of objects organized based on a structure and/or a theme, such as a timeline, a workflow, a project, a role or function, and the like. Moreover, the virtual desktop may arrange these themes so that a user can move to the objects associated with a given theme. In the example of FIG. 1A, the virtual desktop may include dozens if not hundreds of objects. However, only a portion of the objects 108A-D are presented within spatial overview navigation tool 200 (which in this example correspond to objects associated the theme of a project, such as hiring a developer).

Referring again to FIG. 1A, the desktop 104 may be configured to allow a user to define the organization of work performed via the desktop. In the example of FIG. 1A, the desktop represents a two dimensional space. The left portion 102 may include the springboard. The right portion 104 may be configured as a navigable space, where objects can be placed. As noted, the right portion/desktop space 104 may be navigated and organized in accordance with a theme, as noted above, or a structure, such as a grid, a time line, a cluster, and/or in any other format. The desktop may also be searchable and/or filterable according to one or more criteria. In the example of FIG. 1A, criteria may filter (or search) only the objects associated with “Hiring an HTML” develop, in which case objects 108A-D would be presented, although a different criteria may result in other objects being presented on the desktop. The desktop may also be configured to support creation, deletion, opening, and printing of objects as well.

In some exemplary implementations, the desktop 100 may be hosted on a variety of platforms, such as personal computers, tablet computers, smart phones, and any other user equipment including at least one processor and at least one memory.

In some exemplary implementations, the desktop 100 may be configured to allow a user to define a workflow comprising one or more objects. In the example of FIG. 1A, a user may define a workflow of objects, such as objects 108A-D. In addition, the workflow may correspond to a business process provided by an ERP system, such as the one described with respect to FIG. 6 below. The objects on the desktop may, as noted, comprise an item, a document, an HTML link, a view, an icon, a business process, a storage location in a collaboration cloud, a note, a report, a contact, and a tool (e.g., a calendar tool, a calculator tool, a map tool, a weather tool, a stock tool, an email tool, a contacts tool, a clock tool, a push enabled application, a news feed, a favorite, a social networking object, and the like). Moreover, the object may correspond to business object including data and methods in a multi-tenant, cloud-based system, as described further below.

The desktop 104 may also allow a user to perform a zoom to allow viewing the details of an object while maintaining the context of the object within the theme or the structure. The desktop may also be configured to allow selection and execution of applications (e.g., with a click) as well as dropping and dragging actions to select, move, and/or perform other actions.

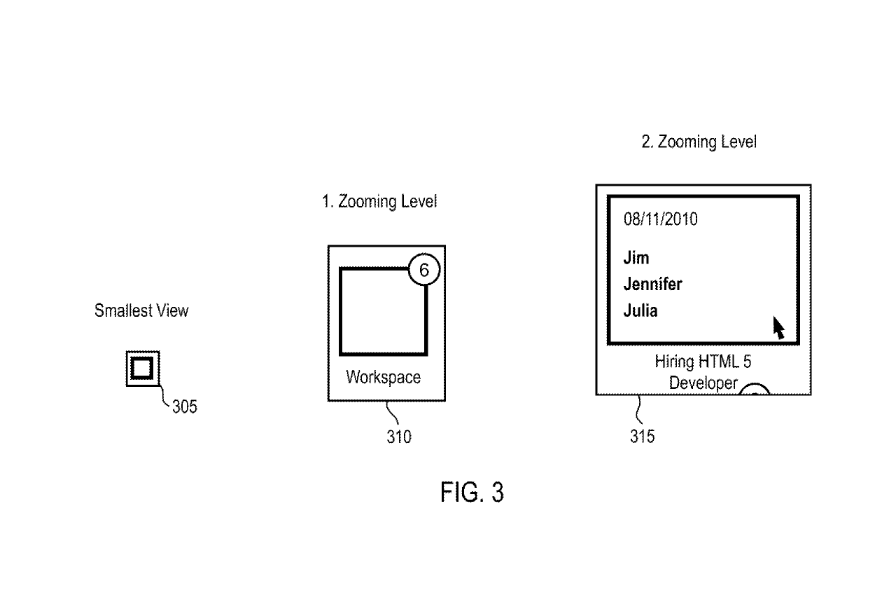

FIG. 3 depicts another example of a multi-level zoom function, which may be configured to allow a user to zoom into an icon or item to view more content. For example, an object on a desktop can be selected, such as icon 305, which in this example is a small pictogram representative of the object. The pictogram is visually distinguishable and identifiable from other objects on the desktop. When a user selects the icon 305 at the desktop, the user may select the icon 305 and vary the zoom level to change the size of the icon to a large view 310 and an even larger view 315. For example, a user may select (e.g., click, scroll, mouse over, and the like), icon 305, and repeatedly select the icon 305 to obtain the larger views 310 and 315. The larger views 310 and 315 may include actual content from the object. The content shown at 430 may be defined by the user.

The virtual desktop and the spatial overview may be configured to allow a user to move readily to objects associated with a given theme, such as a task, a role, and the like. Moreover, the virtual desktop may be configured to allow a user to define comments (e.g., virtual sticky notes) for a given portion of the desktop and place them according to a structure or theme on the desktop.

The virtual desktop 300 may be organized, as noted, in a variety of ways. For example, a user may define that objects are to be organized according to time (e.g., activities assigned to time axis based on dates, deadlines, and the like). The user may also organize objects based on a predefined business processes. The user may also organize objects based on non-work related themes. For example, the user may organize objects on virtual desktop 300 for personal use (e.g., objects related to personal contacts, calendars, and photos).

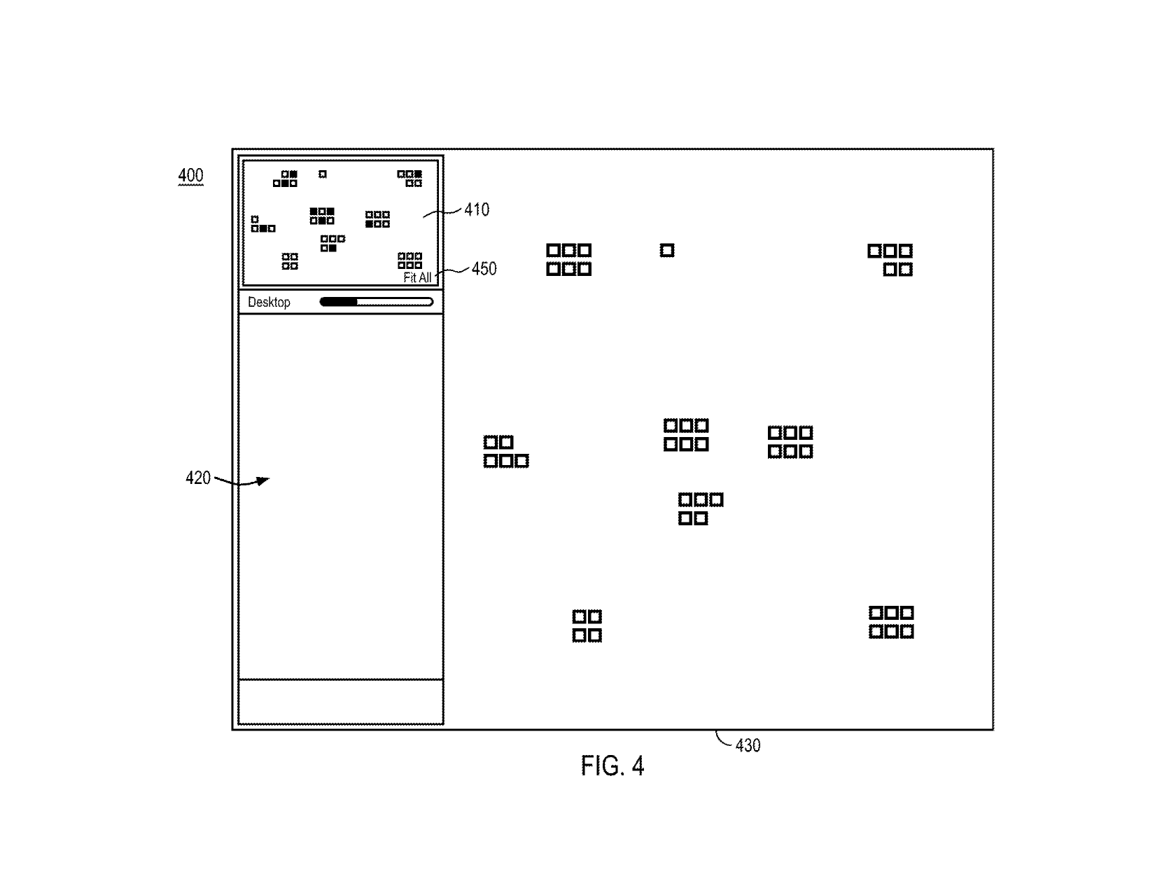

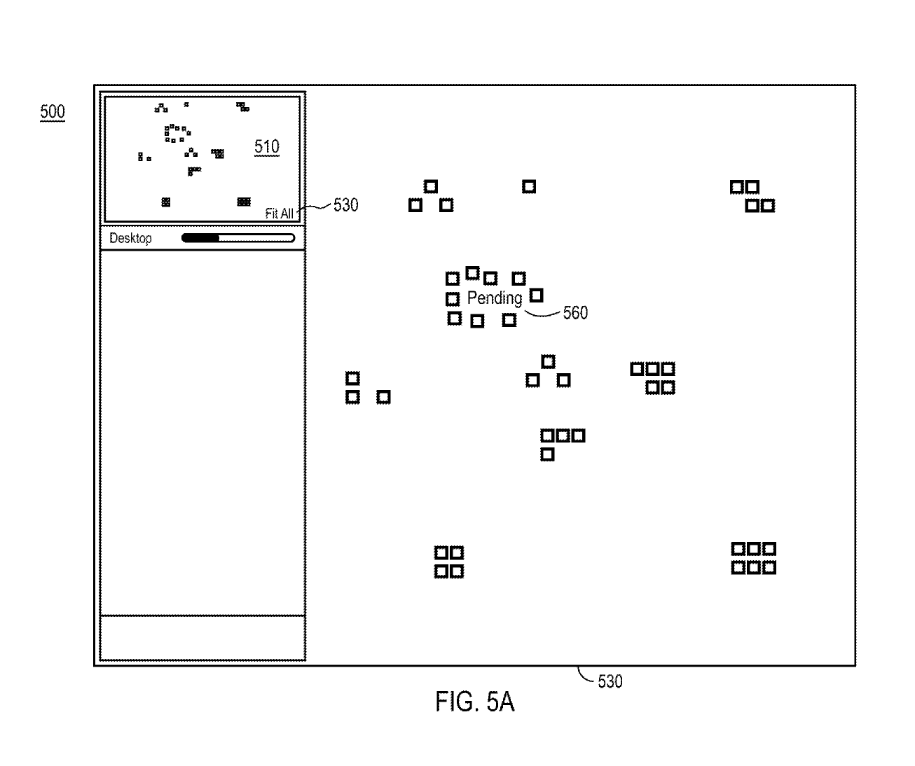

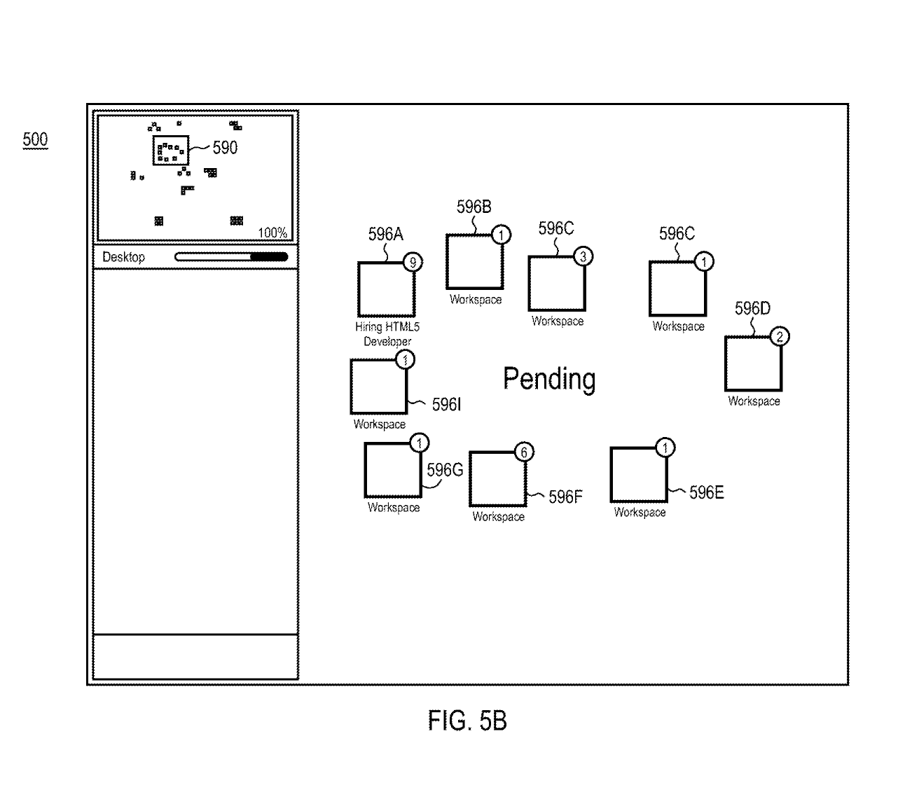

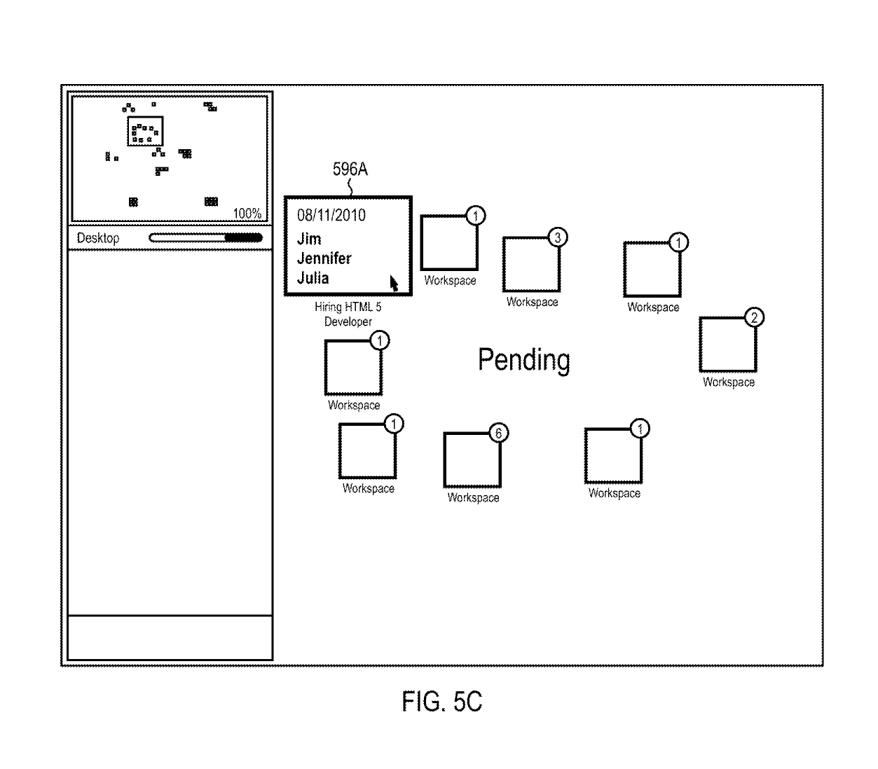

FIGS. 4, 5A, 5B, and 5C depict examples of wireframes. In particular, FIG. 4 depicts a desktop 400 including a spatial overview 410, a springboard 420, and a virtual desktop 430 including objects (represented by polygons). In the example of FIG. 4, a selection of “Fits All” 450 places all of the objects on the virtual desktop 430.

FIG. 5A depicts a desktop 500 including a spatial overview 510, a springboard 520, and a virtual desktop 530 including objects (represented by polygons). In the example of FIG. 5A, a selection of Fits All 550 places all of the objects on the virtual desktop 530.

FIG. 5B also depicts that the objects 560 are pending to be completed as part of a work list or work flow being handled by, for example, an ERP system, such as for example the one described below with respect to FIG. 6. FIG. 5B depicts navigation pane 590 presenting pending objects 596A-I. The navigation pane 590 can be moved (e.g., using a mouse or other controller) to other objects.

FIG. 5C depicts multi-level zooming to an object 596A to view content within the object.

Although the disclosed virtual desktop may be used on a variety of platforms, in some implementations, the disclosed virtual desktop may be used in conjunction with an ERP, such as the one described with respect to FIG. 6.

FIG. 6 shows a block diagram of a multi-tenant implementation of a software delivery architecture 600 that includes an application server 602, which can in some implementations include multiple server systems 604 that are accessible over a network 606 from client machines operated by users at each of multiple organizations 610A-610C (referred to herein as “tenants” of a multi-tenant system) supported by a single software delivery architecture 600.

FIG. 6 also depicts a desktop generator 690 for generating the desktops including springboard toolbars as disclosed herein. Although FIG. 6 depicts a location for desktop generator 690, desktop generator 690 may be located in other locations as well. Moreover, the desktop generator 690 may be distributed among multiple locations.

For a system in which the application server 602 includes multiple server systems 604, the application server can include a load balancer 612 to distribute requests and actions from users at the one or more organizations 610A-610C to the one or more server systems 604. A user can access the delivery architecture across the network using a thin client, such as for example a web browser or the like, or other portal software running on a client machine. The desktops disclosed herein may be presented and/or implemented at the user interfaces associated with 610A-610C.

The application server 602 can access objects, such as data, data objects, and the like, stored in one or more data repositories 616. The application server 602 can also serve as a middleware component via which access is provided to one or more external software components 606.

A multi-tenant system such as that described herein can include one or more of support for multiple versions of the core software, backwards compatibility with older versions, stateless operation in which little, or no, user data or business data are retained at the thin client, and little, or no, need for tenant configuration on the central system. As noted above, in some implementations, support for multiple tenants can be provided using an application server 602 that includes multiple server systems 604 that handle processing loads distributed by a load balancer 612. Potential benefits from such an arrangement can, in some implementations, include, high and reliably continuous application server availability and minimization of unplanned downtime, phased updating of the multiple server systems 304 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 6, the metadata repository 616 can store a business object that represents a template definition of a standard business process, such as a workflow. Each individual tenant 610A-610C can customize that standard template according to the individual business process features specific to business of the organization to which that tenant is assigned. Customizations can be stored as extensions in the metadata repository.

To provide for customization of the business process for each of multiple organizations supported by a single software delivery architecture 600, the data and data objects stored in the metadata repository 616 and/or other data repositories that are accessed by the application server 602 can include three types of content as shown in FIG. 7: core software platform content 702 (e.g. a standard definition of a business process), system content 704, and tenant content 706.

Core software platform content 702 may include content that represents core functionality and is not modifiable by a tenant.

System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 110A-110N can store information about its own inventory, sales order, etc.

Tenant content 706A-706N may include data objects or extensions to other data objects that are customized for one specific tenant 610A-610N to reflect business processes and data (e.g., business objects) that are specific to that specific tenant and are accessible only to authorized users at the corresponding tenant. Such data objects can include a key field (for example “client” in the case of inventory tracking) as well as one or more of master data, business configuration information, transaction data, or the like. For example, tenant content 406 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like).

FIG. 8 depicts an example process 800 for generating a springboard, in accordance with some exemplary implementations.

At 810, a desktop may be generated. The virtual desktop may include a plurality of objects organized according to a structure or a theme. As noted above, the virtual desktop may include a plurality of objects, a portion of which are presented at a user interface, while another portion of the objects may be virtually maintained and viewed at the user interface when a navigation pane is used to move to the objects. In some exemplary implementations, the desktop generator 690 generates the virtual desktops and the features described herein with respect to the desktop.

At 820, a toolbar, such as the springboard toolbar, may be generated and then provided for use with the virtual desktop. Referring to the example depicted at FIG. 1E, springboard toolbar 152B may presented and configured to allow selection. The springboard toolbar 152B may include an object, such as inbox 152I, providing a first view 192A of the object (which in this example is an inbox including a to-do list, although other objects may be used as well), and the object is configured to allow multi-level view.

At 830, a second view representative of the object may be generated and/or presented. For example, a second view 180Y may be presented at a desktop. Moreover, a third view representative of the object may also be generated and/or presented. For example, a third view 180Z may be presented at a desktop. The views 192A, 180Y, and 180Z may show progressively more content of the object. For example, views 192A shows the number of items in the to-do list, view 180Y shows the titles of some of the to-do items, and view 180Z shows additional details. Moreover, the progression from views 192A, 180Y, and 180Z may be invoked by repeatedly selecting the item (e.g., repeatedly right clicking, scrolling a mouse wheel, and the like). Furthermore, views 192A, 180Y, and 180Z maintain their context (e.g., position within the toolbar), when the multi-level zoom is performed.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A computer-readable medium containing instructions to configure at least one processor to perform operations comprising:
generating a desktop including a plurality of objects organized in accordance with at least one of a theme and a structure;
generating a toolbar configured for presentation with the desktop, the toolbar being configured with at least one of the plurality of objects presented as a first view configured for multi-level zoom; and
generating, based on the multi-level zoom, a second view representative of the at least one of the plurality of objects and a third view representative of the at least one of the plurality of objects, the second view providing more content of the at least one of the plurality of objects when compared to the first view, and the third view providing more content of the at least one of the plurality of objects when compared to the second view, the first, second, and third views maintaining the same context within the toolbar, when presented with respect to the toolbar.

2. The computer-readable medium of claim 1, wherein the theme comprises at least one of a project, a role of a user, and a work flow.

3. The computer-readable medium of claim 1, wherein the structure comprises a grid.

4. The computer-readable medium of claim 1, wherein the plurality of objects comprise a plurality of graphical elements, and wherein at least one of the graphical elements represents a link to an action on a business object in a enterprise resource planning system.

5. The computer-readable medium of claim 1, wherein a first selection of the multi-level zoom at the toolbar provides the second view, and a second selection of the multi-level zoom at the toolbar provides the third view.

6. A method comprising:
generating a desktop including a plurality of objects organized in accordance with at least one of a theme and a structure;
generating a toolbar configured for presentation with the desktop, the toolbar being configured with at least one of the plurality of objects presented as a first view configured for multi-level zoom; and
generating, based on the multi-level zoom, a second view representative of the at least one of the plurality of objects and a third view representative of the at least one of the plurality of objects, the second view providing more content of the at least one of the plurality of objects when compared to the first view, and the third view providing more content of the at least one of the plurality of objects when compared to the second view, the first, second, and third views maintaining the same context within the toolbar, when presented with respect to the toolbar.

7. The method of claim 6, wherein the theme comprises at least one of a project, a role of a user, and a work flow.

8. The method of claim 6 wherein the structure comprises a grid.

9. The method of claim 6, wherein the plurality of objects comprise a plurality of graphical elements, and wherein at least one of the graphical elements represents a link to an action on a business object in a enterprise resource planning system.

10. The method of claim 6, wherein a first selection of the multi-level zoom at the toolbar provides the second view, and a second selection of the multi-level zoom at the toolbar provides the third view.

11. A system comprising:
at least one processor; and
at least one memory including code which when executed by the at least one processor provides operations comprising:
generating a desktop including a plurality of objects organized in accordance with at least one of a theme and a structure;
generating a toolbar configured for presentation with the desktop, the toolbar being configured with at least one of the plurality of objects presented as a first view configured for multi-level zoom; and
generating, based on the multi-level zoom, a second view representative of the at least one of the plurality of objects and a third view representative of the at least one of the plurality of objects, the second view providing more content of the at least one of the plurality of objects when compared to the first view, and the third view providing more content of the at least one of the plurality of objects when compared to the second view, the first, second, and third views maintaining the same context within the toolbar, when presented with respect to the toolbar.

12. The system of claim 11, wherein the theme comprises at least one of a project, a role of a user, and a work flow.

13. The system of claim 11, wherein the structure comprises a grid.

14. The system of claim 11, wherein the plurality of objects comprise a plurality of graphical elements, and wherein at least one of the graphical elements represents a link to an action on a business object in a enterprise resource planning system.

15. The system of claim 11, wherein a first selection of the multi-level zoom at the toolbar provides the second view, and a second selection of the multi-level zoom at the toolbar provides the third view.
